(19) United States
(12) Patent Application Publication
(10) Pub. No.: US 2022/0246110 A1
(43) Pub. Date: Aug. 4, 2022

(54) DPU ENHANCEMENT FOR IMPROVED HDCP USER EXPERIENCE

(71) Applicant: QUALCOMM Incorporated, San Diego, CA (US)

(72) Inventors: Deepak MUDDEGOWDA, Bengaluru (IN); Christian WIESNER, Uxbridge (CA); John Chi Kit WONG, Aurora (CA)

(21) Appl. No.: 17/164,604

(22) Filed: Feb. 1, 2021

(51) Int. Cl. G09G 5/00

(52) U.S. Cl. CPC G09G 5/001; G09G 2360/18; G09G 2358/00

(57) ABSTRACT

This disclosure provides systems, devices, apparatuses, and methods, including computer programs encoded on storage media, for a DPU enhancement that provides an improved HDCP user experience. A display processor may configure a plurality of frames for a display panel, where each of the plurality of frames may be associated with an authentication level. The display processor may determine whether the authentication level of at least one frame of the plurality of frames is greater than an authentication level of the display panel and, if the authentication level of the at least one frame is greater than the authentication level of the display panel, the display panel may skip/drop a transmission of the at least one frame to the display panel.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a GPU and/or a display processor.

Content that is generated/encrypted based on a higher authentication level may not be rendered/displayed on a display panel that is configured based on a lower authentication level. As display processors having multiple display ports may not be configured to determine which of the multiple display ports different display panels of different authentication levels are connected, the display processor may drop a received frame of a higher authentication level whenever a display panel of a lower authentication level than that of the received frame is connected to one of the display ports of the display processor. Accordingly, there is a need for improved display processing techniques.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may configure a plurality of frames for a display panel, each of the plurality of frames associated with an authentication level; determine whether the authentication level of at least one frame of the plurality of frames is greater than an authentication level of the display panel; and skip transmission of the at least one frame to the display panel based on the authentication level of the at least one frame being greater than the authentication level of the display panel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 is a call flow diagram illustrating example communications between a display processor and a display panel in accordance with one or more techniques of this disclosure.

FIG. 3 is a diagram illustrating a display processor configured to provide a content security feature in accordance with one or more techniques of this disclosure.

FIG. 4 is a diagram for programming one or more secure registers of a display processor in accordance with one or more techniques of this disclosure.

FIG. 5 is a diagram for dropping a frame at a display processor during composition of the frame in accordance with one or more techniques of this disclosure.

FIG. 6A illustrates example memory blocks that include context memory banks of different authentication levels in accordance with one or more techniques of this disclosure.

FIG. 6B illustrates a table indicative of authentication parameters in accordance with one or more techniques of this disclosure.

FIG. 7 is a flowchart of an example method of display processing in accordance with one or more techniques of this disclosure.

FIG. 8 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

High-bandwidth digital content protection (HDCP) may be utilized to encrypt data transferred from a source to a display panel. HDCP may be based on a plurality of authentication levels, such as a HDCP 2.x authentication level, a HDCP 1.x authentication level, etc. Different display panels may be configured based on different authentication levels included in the plurality of authentication levels. For example, a first display panel may correspond to a HDCP 2.x display panel and a second display panel may correspond to a HDCP 1.x display panel. Content that is generated/encrypted based on HDCP 2.x may not be rendered/displayed on a display panel that is configured based on HDCP 1.x, as the HDCP 1.x display panel may be associated with a lower authentication level than the HDCP 2.x content.

As some display processors may be configured with multiple display ports for providing received content to multiple display panels, a first display panel connected to the display processor may be HDCP 2.x compliant, whereas a second display panel connected to the display processor may be HDCP 1.x compliant. Thus, HDCP 2.x frames received by the display processor may be dropped so that HDCP 2.x content is not provided to a HDCP 1.x display panel connected to one of the multiple display ports of the display processor. That is, decryption of HDCP 2.x content may not proceed when the HDCP 1.x display panel is connected to a display port of the display processor. Dropping the HDCP 2.x content whenever the HDCP 1.x display panel is connected to one of the display ports may ensure that the HDCP 2.x content is not incorrectly provided for display on the HDCP 1.x display panel via the display port of the HDCP 1.x display panel. As such, even in cases where an HDCP 2.x display panel is connected to the display processor for receiving the HDCP 2.x content, the HDCP 2.x display panel may not receive the HDCP 2.x content so long as there is a HDCP 1.x display panel connected to one of the other display ports of the display processor, as the display processor may not be configured to determine which display panel will receive the HDCP 2.x content.

Accordingly, secure software executed by the display processor may be configured to program a buffer address for a decrypted frame and a scope of the buffer into one or more secure registers. The scope of the buffer may be associated with an authentication level of the content included in the decrypted frame. When a display driver attempts to render the frame based on an address of the frame, the display processor may compare the address of the frame with the address of the one or more secure registers and may further compare the scope of the buffer with a scope of the corresponding display port. If the information matches, the display processor may allow composition of the frame. If the information does not match, the display processor may drop/block transmission of the frame to the display panel. In this manner, HDCP 2.x content may be dropped by the display processor when a HDCP 1.x display panel is connected to the corresponding display port of the display processor, but may be rendered and transmitted by the display processor when a HDCP 2.x display panel is connected to the corresponding display port of the display processor.

Additionally or alternatively, the display processor may determine a mapping of the frame to a context memory bank of a plurality of context memory banks based on the authentication level and/or protection level of the frame. The context memory banks may include both non-secure memory and secure memory, where the secure memory may be separated into further levels of authentication. For example, HDCP 1.x content may be mapped to an address space of a secure HDCP 1.x context memory bank, HDCP 2.x content may be mapped to an address space of a secure HDCP 2.x context memory bank, and non-HDCP secure content or other secure HDCP content may be mapped to an address space of one or more other secure context memory banks. Similarly, background content may be mapped to an address space of a non-secure context memory bank. Based on a corresponding buffer identifier, the display processor may determine whether the frame is mapped to a context memory bank that corresponds to the buffer identifier, such that the frame may be rendered and transmitted to the display panel by the display processor when the context memory bank corresponds to the buffer identifier and may be dropped/blocked by the display processor when the context memory bank does not correspond to the buffer identifier.

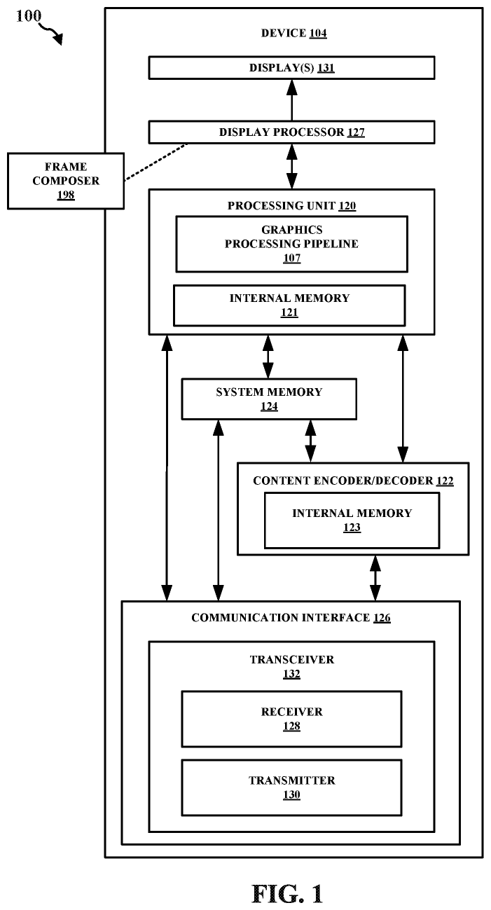

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of optional components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before the frames are displayed by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a frame composer 198 that may configure a plurality of frames for a display panel, each of the plurality of frames associated with an authentication level; determine whether the authentication level of at least one frame of the plurality of frames is greater than an authentication level of the display panel; and skip transmission of the at least one frame to the display panel based on the authentication level of the at least one frame being greater than the authentication level of the display panel. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

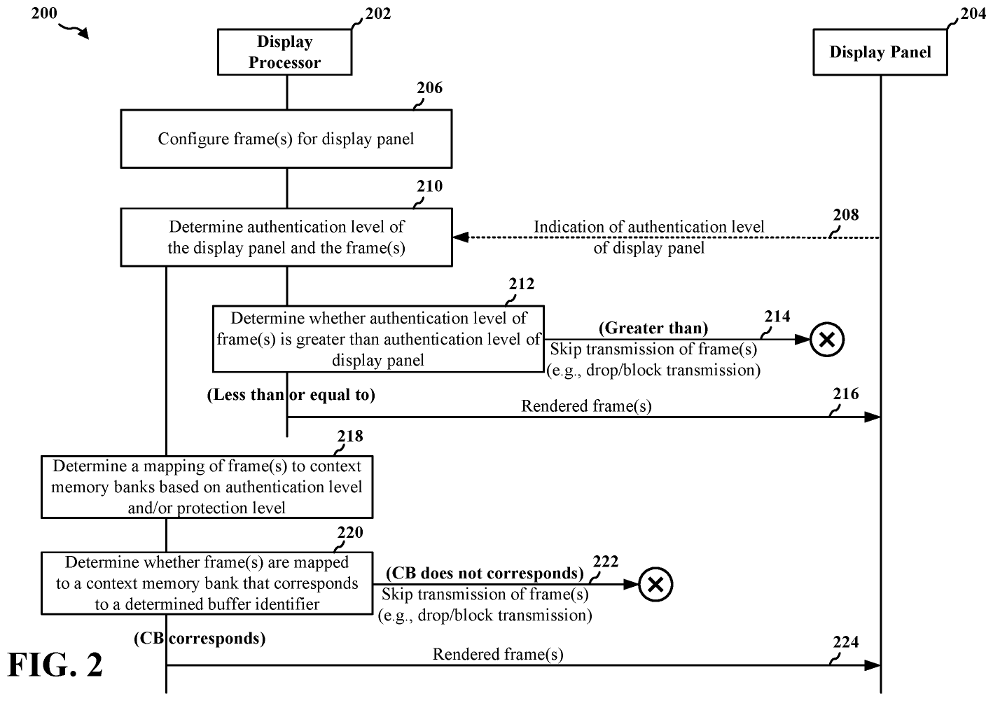

FIG. 2 is a call flow diagram 200 illustrating example communications between a display processor 202 and a display panel 204 in accordance with one or more techniques of this disclosure. At 206, the display processor 202 may configure frame(s) for the display panel 204. The frame(s) may correspond to content such as high-bandwidth digital content protection (HDCP) 2.x content, HDCP 1.x content, background content, etc. At 208, the display processor 202 may receive an indication from the display panel 204 of an authentication level of the display panel 204. For example, the display panel 204 may be a HDCP 2.x display panel, a HDCP 1.x display panel, a non-HDCP display panel, a non-secure display panel, or other type of display panel. The indication from the display panel 204 may be received by the display processor 202 upon a connection being established between the display panel 204 and the display processor 202. Based on the configuration of the frame(s), at 206, and the indication received, at 208, from the display panel 204, the display processor 202 may determine, at 210, an authentication level of the display panel 204 and an authentication level of the frame(s).

At 212, the display processor 202 may determine whether the authentication level of the frame(s) is greater than the authentication of the display panel. If the authentication level of the frame(s) is greater than the authentication level of the display panel 204, the display processor 202 may skip, at 214, transmission of the frame(s) to the display panel 204, such as by dropping the frame(s) and/or blocking transmission of the frame(s) to the display panel 204. For example, if the authentication level of the frame(s) is based on HDCP 2.x but the authentication level of the display panel 204 is based on HDCP 1.x, the display processor 202 may skip, at 214, transmission of the frame(s) to the display panel 204. If the authentication level of the frame(s) is less than or equal to the authentication level of the display panel 204, the display processor may render and transmit, at 216, rendered frame(s) to the display panel 204. For example, if the authentication level of the frame(s) is based on HDCP 2.x and the authentication level of the display panel 204 is based on HDCP 2.x, the display processor 202 may transmit, at 216, the rendered frame(s) to the display panel 204.

Additionally or alternatively to the determination at 212, the display processor 202 may determine, at 218, a mapping of frame(s) to context memory banks based on the authentication level and/or a protection level of the frame(s). For example, a first frame based on HDCP 2.x content may be mapped to a first context memory bank associated with the HDCP 2.x content, a second frame based on HDCP 1.x content may be mapped to a second context memory bank associated with the HDCP 1.x content, a third frame based on non-HDCP or other secure content may be mapped to a third context memory bank associated with the non-HDCP and other secure content, and/or a fourth frame based on non-secure content may be mapped to a fourth context memory bank associated with the non-secure content. Each of the frames may correspond to a buffer identifier. At 220, the display processor 202 may determine whether each of the frame(s) is mapped to a context memory bank that corresponds to a determined buffer identifier for each of the frames.

If the context memory bank to which the frame(s) are mapped does not correspond to the determined buffer identifier for the frame(s), the display processor 202 may skip, at 222, transmission of the frame(s) to the display panel 204, such as by dropping the frame(s) and/or blocking transmission of the frame(s) to the display panel 204. For example, if the context memory bank to which the frame(s) are mapped corresponds to a HDCP 2.x authentication level but the buffer identifier for the frame(s) corresponds to a HDCP 1.x authentication level, the display processor 202 may skip, at 222, transmission of the frame(s) to the display panel 204. If the context memory bank to which the frame(s) are mapped does correspond to the determined buffer identifier for the frame(s), the display processor 202 may render and transmit, at 224, rendered frame(s) to the display panel 204. For example, if the context memory bank to which the frame(s) are mapped corresponds to a HDCP 2.x authentication level and the buffer identifier for the frame(s) corresponds to a HDCP 2.x authentication level, the display processor 202 may transmit, at 224, the rendered frame(s) to the display panel 204.

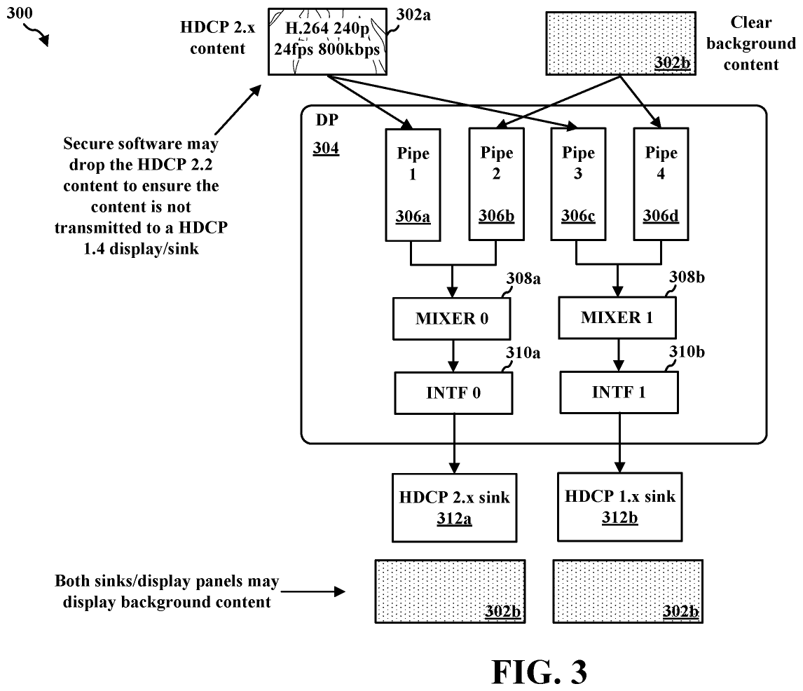

FIG. 3 is a diagram 300 illustrating a display processor 304 configured to provide a content security feature in accordance with one or more techniques of this disclosure. In configurations, HDCP may be utilized to encrypt data transferred from a source to a display panel (e.g., display panels 312a-312b). For example, data transferred from a mobile device to a high-definition multimedia interface (HDMI) panel may be encrypted based on HDCP. Thus, content may not be compromised during communication of the content to the display panel (e.g., 312a-312b) as such content may be secure content associated with a decryption key for decoding the secure content. The decryption key may be communicated from the source to the display panel prior to a content encryption procedure. For example, the decryption key may be transmitted to the display panel (e.g., 312a-312b) responsive to an indication from the display panel (e.g., 312a-312b) of an authentication level of the display panel (e.g., 312a-312b).

HDCP may include a plurality of authentication levels (e.g., HDCP 1.x, HDCP 2.x, etc.). The display panels 312a-312b may be configured based on an authentication level included in the plurality of authentication levels. For example, a first display panel 312a may correspond to a HDCP 2.x sink, such as a HDCP 2.2 sink, and a second display panel 312b may correspond to a HDCP 1.x sink, such as a HDCP 1.4 sink, where the sink is a device that receives data over one or more communication lines and/or input/output (I/O) channels. Generated content and a protocol for encrypting the generated content may be different for the display panel 312a configured based on HDCP 2.x and the display panel 312b configured based on HDCP 1.x. The content that is generated/encrypted based on HDCP 2.x may not be rendered/displayed on the display panel 312a configured based on HDCP 1.x, as HDCP 2.x content may be associated with a higher authentication level than a HDCP 1.x display panel.

In aspects, the HDCP 2.x content 302a may be based on parameters such as a H.264 video coding format, 240 progressive (240p) video (e.g., having 240 vertical pixels), a frame rate of 240 frames-per-second (FPS), and/or a data rate of 8,000 kilobits-per-second (Kbps). The HDCP 2.x content 302 as well as background content 302b (e.g., clear background content) may be received from a source by processing pipes 306a-306d of the display processor 304. A first pipe 306a may receive the HDCP 2.x content 302a and a second pipe 306b may receive the background content 302b, where the first pipe 302a and the second pipe 306b may provide the HDCP 2.x content 302a and the background content 302b to mixer 0 308a. Similarly, a third pipe 306c may also receive the HDCP 2.x content 302a and a fourth pipe 306d may also receive the background content 302b, where the third pipe 302c and the fourth pipe 306d may provide the HDCP 2.x content 302a and the background content 302b to mixer 1 308b. The display panels 312a-312b may receive content from the mixers 308a-308b via respective interfaces (INTFs) (e.g., INTF 0 310a and INTF 1 310b).

Some hardware configurations may include multiple display ports for displaying content received from the source. While the display processor 304 may be associated with 2 display ports, other hardware configurations may correspond to 5-6 or more display ports. Based on different INTFs (e.g., INTF 0 310a and INTF 1 310b) being associated with different display ports for providing content to the display panels 312a-312b of different HDCP authentication levels, secure software executed by the display processor 304 may cause the HDCP 2.x content 302a to be dropped, rather than allowing the HDCP 2.x content 302a to be decrypted. Dropping the HDCP 2.x content 302a whenever the HDCP 1.x display panel 312b is connected to one of the display ports of the display processor 304 may ensure that the HDCP 2.x content 302a is not rendered and incorrectly provided for display on the HDCP 1.x display panel 312b via the display port of the HDCP 1.x display panel 312b. Since the driver that configures the display panels 312a-312b may be associated with separate secure software protocols, the display processor 304 may not be configured to determine which of the display panels 312a-312b will receive the HDCP 2.x content 302a.

Accordingly, even though the HDCP 2.x display panel 312a may be connected to a display port of the display processor 304, the HDCP 2.x display panel 312a may not display the HDCP 2.x content 302a while the HDCP 1.x display panel 312b is connected to another display port of the display processor 304, since the display processor 304 may not be configured to determine which of the display panels 312a-312b will receive the HDCP 2.x content 302a. In particular, after decoding a secure buffer, the secure software may not be configured to determine through which INTF 310a-310b the decoded frame will be provided for display. Thus, the frame received by the display processor 304 may be dropped at one of the mixers 308a-308b based on the received frame being of a higher authentication level than an authentication level of one of the connected display panels (e.g., the HDCP 1.x display panel 312b). As a result, both sinks/display panels 312a-312b may instead display the background content 302b that does not exceed the authentication level of either of the display panels 312a-312b.

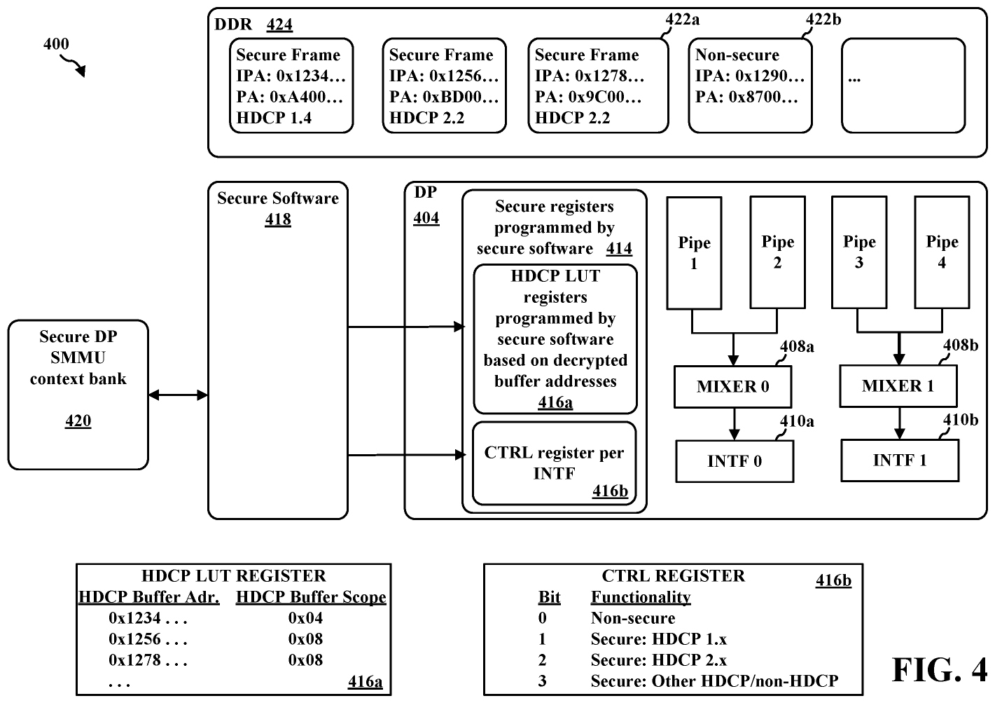

FIG. 4 is a diagram 400 for programming one or more secure registers 414 of a display processor 404 in accordance with one or more techniques of this disclosure. The one or more secure registers 414 may be programmed by secure software 418 in association with an INTF (e.g., INTFs 410a-410b) of the display processor 404 based on a sink authentication level. In aspects, the secure software 418 may update a HDCP look-up table (LUT) register 416a based on intermediate physical addresses (IPAs) determined from a decrypted buffer. The HDCP LUT registers 416a of the display processor 404 may be programmed by the secure software 418 instead of by a display driver. The secure software 418 may program the IPA of the buffer to the HDCP LUT register 416a when the secure software 418 decrypts each frame.

The secure software 418 may also program a scope of a secure frame 422a. As secure buffers may be mapped to a secure system memory management unit (SMMU) of the display processor 404, the secure software 418 may access a context memory bank 420 of the secure SMMU of the display processor 404. During composition of a frame, the display processor 404 may determine (e.g., via the mixers 408a-408b) whether the frame being fetched corresponds to the HDCP LUT register 416a. The display processor 404/mixers 408a-408b may determine the IPA of the buffer based on a current source address (CURRENT_SRC_ADDR) register. If the IPA is included in the HDCP LUT register 416a, the display processor 404/mixers 408a-408b may compare a scope of the buffer in the HDCP LUT register 416a to a control (CTRL) register 416b to determine whether to drop the frame.

Accordingly, the one or more secure registers 414 programmed by the secure software 418 may correspond to two different register types. The CTRL register 416b may be a secure, per port (e.g., INTF 0 410a or INTF 1 410b) register for the secure software 418. Each port may correspond to one register having an indicated scope, which may be programmed by the secure software 418. Thus, the secure software 418 may determine whether a connected display panel is associated with a HDCP 1.x authentication level, a HDCP 2.x authentication level, etc. Based on the determination, the secure software 418 may program the CTRL register 416b. For example, the secure software 418 may program the CTRL register 416b with bit 0 if the authentication level is non-secure, the secure software 418 may program the CTRL register 416b with bit 1 if the authentication level is (secure) HDCP 1.x, the secure software 418 may program the CTRL register 416b with bit 2 if the authentication level is (secure) HDCP 2.x, and the secure software 418 may program the CTRL register 416b with bit 3 if the authentication level is for other HDCP/non-HDCP.

A frame configured with a clear content background may be a non-secure frame 422b, whereas a frame configured based on HDCP 2.x content may be a secure frame 422a. When a frame is received from a content provider, the secure software 418 may execute a protocol to decrypt the data for the frame. The secure software 418 may generate a physical address (PA) for the frame in double data rate (DDR) memory 424, which may correspond to an IPA and an authentication level of the frame. The PA may be mapped to the SMMU. Thus, the secure software 418 may program a mapped HDCP buffer address (e.g., 0x1234, 0x1256, 0x1278, etc.) and a HDCP buffer scope (e.g., 0x04, 0x08, 0x8, etc.) to the HDCP LUT register 416a. While decrypting the buffer and determining an IPA of the buffer, the secure software 418 may determine that the content is HDCP 2.x content, such that the HDCP buffer addresses may also be programed to the display processor 404 (e.g., by the secure software 418, rather than the display driver). As the display driver may not edit the one or more secure registers 414, the programming procedure may be secure.

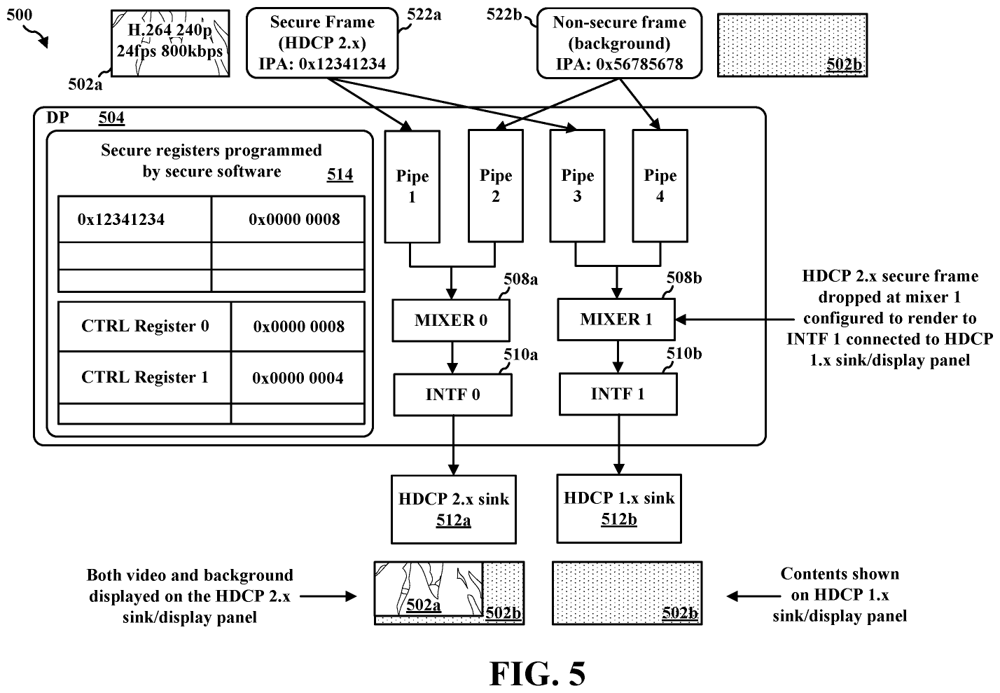

FIG. 5 is a diagram 500 for dropping a frame at a display processor 504 during composition of the frame in accordance with one or more techniques of this disclosure. For example, a secure frame 522a (e.g., HDCP 2.x content 502a) may be dropped at one of the mixers 508a-508b of the display processor 504. If two frames are to be rendered, where a first frame is a non-secure frame 522b (e.g., background content 502b) and a second frame is a secure frame 522a (e.g., HDCP 2.x content 502a), the non-secure frame 522b /background content 502b may be provided to both the HDCP 2.x display panel 512a and the HDCP 1.x display panel 512b, but the secure frame 522a /HDCP 2.x content 502a may not be provided to both display panels 512a-512b. The secure software may determine that a secure frame 522a includes HDCP 2.x content 502a and may not determine the device type connected, e.g., at INTF 0 510a and/or INTF 1 510b. The secure software may decrypt the secure frame 522a and program a buffer address (e.g., IPA: 0x12341234) into the one or more secure registers 514. The secure software may also program the scope of the buffer (e.g., 0x0000 0008) into the one or more secure registers 514. The scope of the buffer may indicate that the frame includes HDCP 2.x content 502a. In aspects, such techniques may be executed for a secure buffer.

If the display driver attempts to program/render an address of the secure frame 522a, the display processor 504 may compare the address of the secure frame 522a with an address of the one or more secure registers 514 and compare the scope of the buffer with the scope of a particular display port (e.g., corresponding to INTF 0 510a or INTF 1 510b). If the information matches, the display processor 504 may allow composition of the secure frame 522a. If the information does not match, the display processor 504 may drop the secure frame 522a. For example, if the scope of the buffer is 0x0000 0008 and the scope of the display port at INTF 0 510a is also 0x0000 0008, the secure frame 522a may be rendered and displayed. However, if the scope of the buffer is 0x0000 0004 (e.g., at INTF 1 510a) but the scope of the display port is 0x0000 0008, the display processor 504 may drop the secure frame 522a (e.g., at mixer 1 508b). Thus, HDCP 2.x content 502a may be dropped for the INTF 1 510b connected to the HDCP 1.x display panel 512b, so that the HDCP 2.x content 502a is not rendered and displayed on the HDCP 1.x display panel 512b. For the HDCP 2.x display panel 512a, the HDCP 2.x content 502a and the background content 502b may be displayed on the HDCP 2.x display panel 512a, while the background content 502b may be displayed on the HDCP 1.x display panel 512b without the secure content.

Two authentication levels may be broadly associated with the SMMU. For example, a first authentication level may correspond to secure/protected content and a second authentication level may correspond to non-secure/unprotected content. Protected content may further include two or more levels of authentication (e.g., legacy/HDCP 1.x, which may correspond to level 0, and HDCP 2.x, which may correspond to level 1). As such, the connection to the sinks/display panels 512a-512b may be two-tiered based on two types of encryption. In order to protect the higher authentication level, a next level of encryption may be implemented.

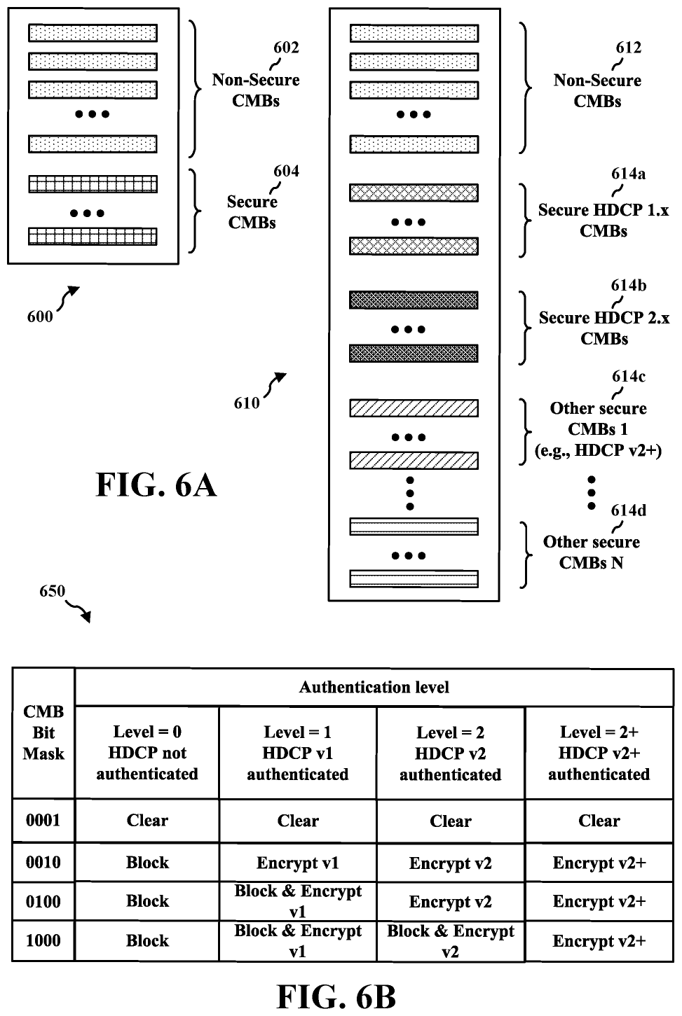

FIGS. 6A-6B illustrate example memory blocks 600-610 that include context memory banks of different authentication levels in accordance with one or more techniques of this disclosure and a corresponding authentication level table 650 indicative of authentication parameters in accordance with one or more techniques of this disclosure. The context memory banks (e.g., of the SMMU) may include both secure memory 604/614a-614d and non-secure memory 602/612. For example, the memory block 600 may be separated into two authentication levels that include non-secure context memory banks 602 and secure context memory banks 604. In configurations associated with the memory block 610, the secure context memory banks 614a-614d may be further separated based on a plurality of authentication levels. For example, secure HDCP 2.x context memory banks (CMBs) 614b may be more secure than secure HDCP 1.x CMBs 614a, which may be more secure than non-secure CMBs 612. The memory block 610 may additionally include other CMBs 614c-614d (e.g., other secure CMBs 1 614c through other secure CMBs N 614d). The other secure CMBs 614c-614d may include any other type of secure memory/content that is different from secure HDCP 1.x content and HDCP 2.x secure content. For example, the other secure CMBs 1 614c may include HDCP version 2+ (HDCP v2+) memory/content having a higher authentication level than HDCP 2.x (e.g., HDCP 3.x or higher), whereas the other CMBs N 614d may include non-HDCP content.

In order to separate the secure context memory banks 604 of the memory block 600 into the secure context memory banks 614a-614d of the memory block 610 having a plurality of authentication levels, a mapping may be determined for data that enters and exits the memory block 610. Increasing levels of authentication for the plurality of authentication levels may correspond to an increase in a memory bit number. For example, the authentication level table 650 illustrates a CMB bit mask for which bit 0001 may correspond to the non-secure CMBs 612, bit 0010 may correspond to the secure HDCP 1.x CMBs 614a, bit 0100 may correspond to the secure HDCP 2.x CMBs 614b, and bit 1000 may correspond to HDCP v2+ CMBs (e.g., of the other secure CMBs 1 614c). Further, the authentication level table 650 illustrates four security states that includes a level 0 state for HDCP not authenticated, a level 1 state for HDCP version 1 (v1) authenticated, a level 2 state for HDCP version 2 (v2) authenticated, and a level 2+ state for HDCP v2+ authenticated.

Rather than adding registers to the SMMU, data mapping techniques may be utilized to integrate security into the SMMU, as the context memory banks 612/614a-614d may have one correct mapping for the data entering and exiting the memory block 610. If cross-bank memory addressing occurs, an unknown address (e.g., noise) may be returned. The particular context memory bank 612/614a-614d that is used for properly reading and writing data may correspond to a particular authentication level. Based on the CMB bit mask used for the particular authentication level, the content may be cleared, blocked, encrypted based on a HDCP version, or blocked and encrypted based on the HDCP version.

A second level of protection may be associated with blocking or obscuring the content when an incorrect mapping occurs with respect to the context memory banks 612/614a-614d. The buffer may be tagged and compared to the state of the encryption at an output of the display processor. If the buffer correctly corresponds to the state of encryption, the data may be communicated to a display panel without blockage or obstruction. Encryption techniques may be based on orthogonality. If a link connecting an exit point of the display processor to a sink/display panel is encrypted by non-secure software, the encrypted content may be compromised. Based on the additional level of authentication, a payload may be obscured if the incorrect mapping occurs with respect to the context memory banks 612/614a-614d.

Accordingly, rather than utilizing registers that are external to bits of the memory blocks 600-610 to enforce address mapping, the mapping may be integrated into the HDCP hardware (e.g., based on the authentication level table 650) used by secure software that determines the correct mapping. Further, the secure memory 614a-614d of the memory block 610 may be separated into further levels of authentication, as opposed to broadly separating the memory into the secure context memory banks 604 and non-secure context memory banks 602 of the memory block 600. That is, HDCP 2.x content may be mapped to an address space of the secure HDCP 2.x context memory banks 614b, HDCP 1.x content may be mapped to an address space of the secure HDCP 1.x context memory banks 614a, other secure content may be mapped to an address space of the other secure context memory banks 614c-614d, and background content may be mapped to an address space of the non-secure context memory banks 612. By separating the secure context memory banks 614a-614d into further levels of authentication, content may not have to be blocked or obscured based on a highest or lowest level of authentication.

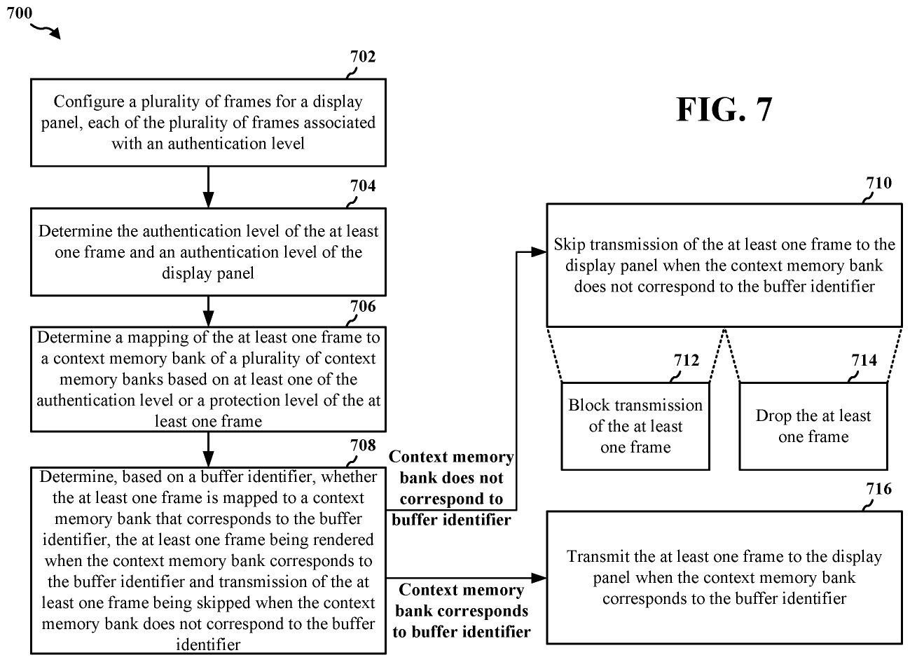

FIG. 7 is a flowchart 700 of an example method of display processing in accordance with one or more techniques of this disclosure. The method may be performed by an apparatus, such as an apparatus for display processing, a DPU or other display processor (e.g., the display processor 127, 202, 304, 404, 504), a wireless communication device, and the like, as used in connection with the examples of FIGS. 1-6.

At 702, the display processor may configure a plurality of frames for a display panel, each of the plurality of frames associated with an authentication level. For example, referring to FIGS. 2-3, the display processor 202 may configure, at 206, frame(s) for the display panel 204. The configured frames may correspond to HDCP 2.x content 302a, background content 302b, etc., associated with different authentication levels.

At 704, the display processor may determine the authentication level of the at least one frame and an authentication level of the display panel. For example, referring to FIG. 2, the display processor 202 may determine, at 210, the authentication level of the frame(s) (e.g., based on the configuration of the frames at 206) and the authentication level of the display panel 204 (e.g., based on the indication received, at 208, from the display panel 204).

At 706, the display processor may determine a mapping of the at least one frame to a context memory bank of a plurality of context memory banks based on at least one of the authentication level or a protection level of the at least one frame. For example, referring to FIGS. 2 and 6A-6B, the display processor 202 may determine, at 218, a mapping of the frame(s) to context memory banks based on the authentication level and/or protection level of the frames. The plurality of context memory banks, as indicated via the memory block 610, may include one or more of a non-secure context memory bank, a HDCP 1.x context memory bank, a HDCP 2.x context memory bank, or one or more different types of secure context memory banks. The non-secure context memory bank may be associated with a first bit (e.g., bit 0) of a bit mask, the HDCP 1.x context memory bank may be associated with a second bit (e.g., bit 1) of the bit mask, the HDCP 2.x context memory bank may be associated with a third bit (e.g., bit 2) of the bit mask, and the different types of secure context memory banks may be associated with a fourth bit (e.g., bit 3) of the bit mask.

At 708, the display processor may determine, based on a buffer identifier, whether the at least one frame is mapped to a context memory bank that corresponds to the buffer identifier, the at least one frame being rendered when the context memory bank corresponds to the buffer identifier and transmission of the at least one frame being skipped when the context memory bank does not correspond to the buffer identifier. For example, referring to FIG. 2, the display processor 202 may determine, at 220, whether the frame(s) are mapped to a context memory bank that corresponds to a determined buffer identifier. If the context memory bank corresponds to the buffer identifier, the frames may be rendered for transmission, at 224, to the display panel. If the context memory bank does not correspond to the buffer identifier, transmission of the frame(s) may be skipped, at 222.

At 710, the display processor may skip transmission of the at least one frame to the display panel when the context memory bank does not correspond to the buffer identifier. For example, referring to FIG. 2, the display processor 202 may skip, at 222, transmission of the frame(s) to the display panel 204 when the context memory bank to which the frames(s) are mapped does not correspond the determined buffer identifier.

At 712, to skip transmission of the at least one frame to the display panel, the display processor may block transmission of the at least one frame. For example, referring to FIG. 2, the display processor 202 may skip transmission of the frame(s), at 222, by blocking transmission of the frame(s) to the display panel 204.

At 714, to skip transmission of the at least one frame to the display panel, the display processor may drop the at least one frame. For example, referring to FIG. 2, the display processor 202 may skip transmission of the frame(s), at 222, by dropping the frame(s) for the display panel 204.

At 716, the display processor may transmit the at least one frame to the display panel when the context memory bank corresponds to the buffer identifier. For example, referring to FIG. 2, the display processor 202 may transmit, at 224, the rendered frame(s) to the display panel 204 when the context memory bank to which the frame(s) are mapped corresponds to the determined buffer identifier.

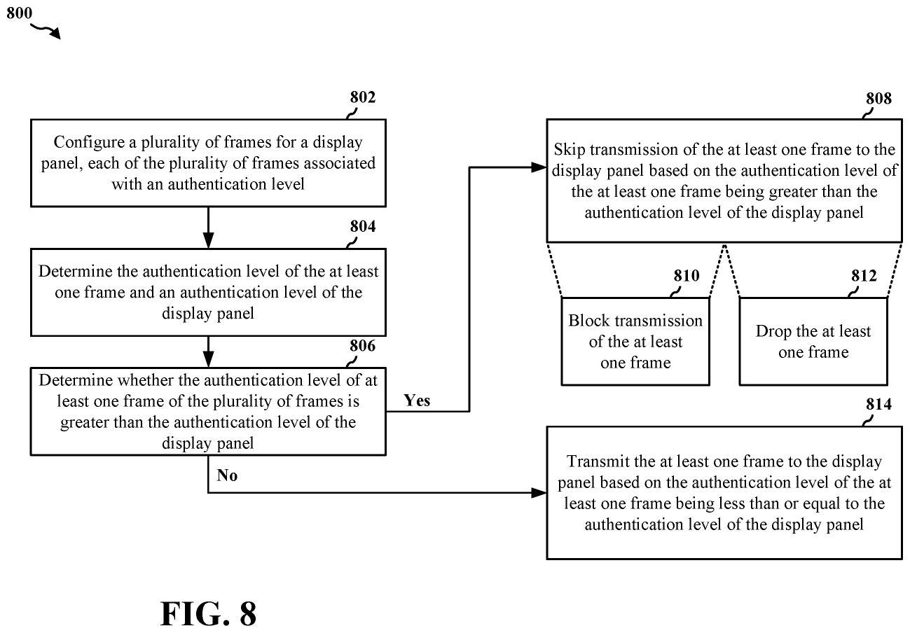

FIG. 8 is a flowchart 800 of an example method of display processing in accordance with one or more techniques of this disclosure. The method may be performed by an apparatus, such as an apparatus for display processing, a DPU or other display processor (e.g., the display processor 127, 202, 304, 404, 504), a wireless communication device, and the like, as used in connection with the examples of FIGS. 1-6.

At 802, the display processor may configure a plurality of frames for a display panel, each of the plurality of frames associated with an authentication level. For example, referring to FIGS. 2-3, the display processor 202 may configure, at 206, frame(s) for the display panel 204. The configured frames may correspond to HDCP 2.x content 302a, background content 302b, etc., associated with different authentication levels.

At 804, the display processor may determine the authentication level of the at least one frame and an authentication level of the display panel. For example, referring to FIG. 2, the display processor 202 may determine, at 210, the authentication level of the frame(s) (e.g., based on the configuration of the frames at 206) and the authentication level of the display panel 204 (e.g., based on the indication received, at 208, from the display panel 204).

At 806, the display processor may determine whether the authentication level of at least one frame of the plurality of frames is greater than the authentication level of the display panel. For example, referring to FIG. 2, the display processor 202 may determine, at 212, whether the authentication level of the frame(s) is greater than the authentication level of the display panel 204.

At 808, the display processor may skip transmission of the at least one frame to the display panel based on the authentication level of the at least one frame being greater than the authentication level of the display panel. For example, referring to FIGS. 2 and 4-5, the display processor 202 may skip, at 214, transmission of the frame(s) to the display panel 204 when the authentication level of the frames(s) is greater than the authentication level of the display panel 204. The transmission of the at least one frame may be skipped, at 214, based on a secure register 414/514 programmed by a secure protocol 418. The secure register 414/514 may be at least one of a HDCP LUT register 416a or a CTRL register 416b. The secure register 414/514 may include a buffer address and an indication of the authentication level of the at least one frame.

At 810, to skip transmission of the at least one frame to the display panel, the display processor may block transmission of the at least one frame. For example, referring to FIG. 2, the display processor 202 may skip transmission of the frame(s), at 214, by blocking transmission of the frame(s) to the display panel 204.

At 812, to skip transmission of the at least one frame to the display panel, the display processor may drop the at least one frame. For example, referring to FIG. 2, the display processor 202 may skip transmission of the frame(s), at 214, by dropping the frame(s) for the display panel 204.

At 814, the display processor may transmit the at least one frame to the display panel based on the authentication level of the at least one frame being less than or equal to the authentication level of the display panel. For example, referring to FIG. 2, the display processor 202 may transmit, at 216, the rendered frame(s) to the display panel 204 when the authentication level of the frame(s) is less than or equal to the authentication level of the display panel 204.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for configuring a plurality of frames for a display panel, each of the plurality of frames associated with an authentication level; means for determining whether the authentication level of at least one frame of the plurality of frames is greater than an authentication level of the display panel; and means for skipping transmission of the at least one frame to the display panel based on the authentication level of the at least one frame being greater than the authentication level of the display panel. In aspects, the means for skipping transmission of the at least one frame to the display panel may be further configured to at least one of drop the at least one frame or block transmission of the at least one frame. The apparatus may further include means for determining a mapping of the at least one frame to a context memory bank of a plurality of context memory banks based on at least one of the authentication level or a protection level of the at least one frame. The apparatus may further include means for determining, based on a buffer identifier, whether the at least one frame is mapped to a context memory bank that corresponds to the buffer identifier, the at least one frame being rendered when the context memory bank corresponds to the buffer identifier and transmission of the at least one frame being skipped when the context memory bank does not correspond to the buffer identifier. The apparatus may further include means for determining the authentication level of the at least one frame and the authentication level of the display panel. The apparatus may further include means for transmitting the at least one frame to the display panel based on the authentication level of the at least one frame being less than or equal to the authentication level of the display panel.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may comprise RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, characterized by: configuring a plurality of frames for a display panel, each of the plurality of frames associated with an authentication level; determining whether the authentication level of at least one frame of the plurality of frames is greater than an authentication level of the display panel; and skipping transmission of the at least one frame to the display panel based on the authentication level of the at least one frame being greater than the authentication level of the display panel.

Aspect 2 may be combined with aspect 1 and is characterized in that the transmission of the at least one frame is skipped based on a secure register programmed by a secure protocol.

Aspect 3 may be combined with any of aspects 1-2 and is characterized in that the secure register is at least one of a HDCP LUT register or a CTRL register.

Aspect 4 may be combined with any of aspects 1-3 and is characterized in that the secure register includes a buffer address and an indication of the authentication level of the at least one frame.

Aspect 5 may be combined with any of aspects 1-4 and is further characterized by determining a mapping of the at least one frame to a context memory bank of a plurality of context memory banks based on at least one of the authentication level or a protection of the at least one frame.

Aspect 6 may be combined with any of aspects 1-5 and is characterized in that the plurality of context memory banks includes one or more of a non-secure context memory bank, a HDCP 1.x context memory bank, a HDCP 2.x context memory bank, or a different type of secure context memory bank.

Aspect 7 may be combined with any of aspects 1-6 and is characterized in that the non-secure context memory bank is associated with a first bit of a bit mask, the HDCP 1.x context memory bank is associated with a second bit of the bit mask, the HDCP 2.x context memory bank is associated with a third bit of the bit mask, and the different type of secure context memory bank is associated with a fourth bit of the bit mask.

Aspect 8 may be combined with any of aspects 1-7 and is further characterized by determining, based on a buffer identifier, whether the at least one frame is mapped to a context memory bank that corresponds to the buffer identifier, the at least one frame being rendered when the context memory bank corresponds to the buffer identifier and transmission of the at least one frame being skipped when the context memory bank does not correspond to the buffer identifier.

Aspect 9 may be combined with any of aspects 1-8 and is further characterized by determining the authentication level of the at least one frame and the authentication level of the display panel.

Aspect 10 may be combined with any of aspects 1-9 and is characterized in that skipping transmission of the at least one frame to the display panel includes at least one of dropping the at least one frame or blocking transmission of the at least one frame.

Aspect 11 may be combined with any of aspects 1-10 and is further characterized by transmitting the at least one frame to the display panel based on the authentication level of the at least one frame being less than or equal to the authentication level of the display panel.

Aspect 12 is an apparatus for display processing including at least one processor coupled to a memory and configured to implement a method as in any of aspects 1-11.

Aspect 13 may be combined with aspect 12 and is characterized in that the apparatus is a wireless communication device.

Aspect 14 is an apparatus for display processing including means for implementing a method as in any of aspects 1-11.

Aspect 15 is a computer-readable medium storing computer executable code, the code when executed by at least one processor causes the at least one processor to implement a method as in any of aspects 1-11.

What is claimed is:

1. A method of display processing, comprising:
configuring a plurality of frames for a display panel, each of the plurality of frames associated with an authentication level;
determining whether the authentication level of at least one frame of the plurality of frames is greater than an authentication level of the display panel; and
skipping transmission of the at least one frame to the display panel based on the authentication level of the at least one frame being greater than the authentication level of the display panel.

2. The method of claim 1, wherein the transmission of the at least one frame is skipped based on a secure register programmed by a secure protocol.

3. The method of claim 2, wherein the secure register is at least one of a high-bandwidth digital content protection (HDCP) look-up table (LUT) register or a control (CTRL) register.

4. The method of claim 2, wherein the secure register includes a buffer address and an indication of the authentication level of the at least one frame.

5. The method of claim 1, further comprising determining a mapping of the at least one frame to a context memory bank of a plurality of context memory banks based on at least one of the authentication level or a protection level of the at least one frame.

6. The method of claim 5, wherein the plurality of context memory banks includes one or more of a non-secure context memory bank, a high-bandwidth content protection (HDCP) 1.x context memory bank, a HDCP 2.x context memory bank, or a different type of secure context memory bank.

7. The method of claim 6, wherein the non-secure context memory bank is associated with a first bit of a bit mask, the HDCP 1.x context memory bank is associated with a second bit of the bit mask, the HDCP 2.x context memory bank is associated with a third bit of the bit mask, and the different type of secure context memory bank is associated with a fourth bit of the bit mask.

8. The method of claim 5, further comprising determining, based on a buffer identifier, whether the at least one frame is mapped to a context memory bank that corresponds to the buffer identifier, the at least one frame being rendered when the context memory bank corresponds to the buffer identifier and transmission of the at least one frame being skipped when the context memory bank does not correspond to the buffer identifier.

9. The method of claim 1, further comprising determining the authentication level of the at least one frame and the authentication level of the display panel.

10. The method of claim 1, wherein skipping transmission of the at least one frame to the display panel includes at least one of dropping the at least one frame or blocking transmission of the at least one frame.

11. The method of claim 1, further comprising transmitting the at least one frame to the display panel based on the authentication level of the at least one frame being less than or equal to the authentication level of the display panel.

12. An apparatus for display processing, comprising:
a memory; and
at least one processor coupled to the memory and configured to:
configure a plurality of frames for a display panel, each of the plurality of frames associated with an authentication level;
determine whether the authentication level of at least one frame of the plurality of frames is greater than an authentication level of the display panel; and
skip transmission of the at least one frame to the display panel based on the authentication level of the at least one frame being greater than the authentication level of the display panel.

13. The apparatus of claim 12, wherein the transmission of the at least one frame is skipped based on a secure register programmed by a secure protocol.

14. The apparatus of claim 13, wherein the secure register is at least one of a high-bandwidth digital content protection (HDCP) look-up table (LUT) register or a control (CTRL) register.

15. The apparatus of claim 13, wherein the secure register includes a buffer address and an indication of the authentication level of the at least one frame.

16. The apparatus of claim 12, wherein the at least one processor is further configured to determine a mapping of the at least one frame to a context memory bank of a plurality of context memory banks based on at least one of the authentication level or a protection level of the at least one frame.

17. The apparatus of claim 16, wherein the plurality of context memory banks includes one or more of a non-secure context memory bank, a high-bandwidth content protection (HDCP) 1.x context memory bank, a HDCP 2.x context memory bank, or a different type of secure context memory bank.

18. The apparatus of claim 17, wherein the non-secure context memory bank is associated with a first bit of a bit mask, the HDCP 1.x context memory bank is associated with a second bit of the bit mask, the HDCP 2.x context memory bank is associated with a third bit of the bit mask, and the different type of secure context memory bank is associated with a fourth bit of the bit mask.

19. The apparatus of claim 16, wherein the at least one processor is further configured to determine, based on a buffer identifier, whether the at least one frame is mapped to a context memory bank that corresponds to the buffer identifier, the at least one frame being rendered when the context memory bank corresponds to the buffer identifier and transmission of the at least one frame being skipped when the context memory bank does not correspond to the buffer identifier.

20. The apparatus of claim 12, wherein the at least one processor is further configured to determine the authentication level of the at least one frame and the authentication level of the display panel.

21. The apparatus of claim 12, wherein to skip transmission of the at least one frame to the display panel the at least one processor is further configured to at least one of drop the at least one frame or block transmission of the at least one frame.

22. The apparatus of claim 12, wherein the at least one processor is further configured to transmit the at least one frame to the display panel based on the authentication level of the at least one frame being less than or equal to the authentication level of the display panel.

23. The apparatus of claim 12, wherein the apparatus is a wireless communication device.

24. A computer-readable medium storing computer executable code, the code when executed by at least one processor, causes the at least one processor to:
configure a plurality of frames for a display panel, each of the plurality of frames associated with an authentication level;
determine whether the authentication level of at least one frame of the plurality of frames is greater than an authentication level of the display panel; and
skip transmission of the at least one frame to the display panel based on the authentication level of the at least one frame being greater than the authentication level of the display panel.
